(19) United States
(12) Patent Application Publication
(10) Pub. No.: US 2024/0354404 A1
(43) Pub. Date: Oct. 24, 2024

(54) MIGRATION OF ATTACKING SOFTWARE AS A MITIGATION TO AN ATTACK BY A MALICIOUS ACTOR

(71) Applicant: Arm Limited, Cambridge (GB)

(72) Inventors: Dominic Phillip Mulligan, Cottenham (GB); Brendan James Moran, Histon (GB); Michael Bartling, Austin, TX (US); Matthias Lothar Boettcher, Cambridge (GB)

(21) Appl. No.: 18/302,354

(22) Filed: Apr. 18, 2023

(51) Int. Cl. G06F 21/55; G06F 21/53

(52) U.S. Cl. CPC G06F 21/554; G06F 21/53; G06F 21/552

(57) ABSTRACT

A method to mitigate an attack initiated by a malicious actor by migration of the attacked process is provided. The method includes monitoring a process being executed from a first computing location on a computing device for a trigger indicating a potential attack and detecting the trigger indicating the potential attack. Responsive to detecting the trigger indicating the potential attack, initiating an attack countermeasure by migrating the process to execute in a second computing location isolated from the first computing location, thereby breaking access to information at the first computing location. A computing device is also provided that includes a processor, a memory, and instructions stored on the memory that when executed by the processor direct the computing device to monitor a process being executed from a first computing location on the computing device for a trigger indicating a potential attack and detect the trigger indicating the potential attack.

### BACKGROUND

In conventional computers and computer networks, an attack refers to various attempts to achieve unauthorized access to technological resources. A malicious actor, or attacker, may attempt to access data, functions, or other restricted areas of a susceptible computing system without authorization. When an attack is detected on software running on the computing system, it can be essential for a defender of the software to address the security of the software in some manner. There are some approaches to mitigate an attack that can have expensive and/or irreversible consequences. For example, flushing a cache or terminating a process, especially if benign behaviors were falsely identified as an attack, can be costly and negatively impact the performance of the computing system.

### BRIEF SUMMARY

A method to mitigate an attack initiated by a malicious actor by migration of the attacked process is provided. When an attack is detected on a computer program running on a computing system, there are a number of countermeasures that are possible. However, by migrating the attacked process away from its current location on a target computing system to another location as described herein, the attack loses some valuable context necessary for successful operation, thereby thwarting the goals of the attacker. For example, if an attacker is trying to steal a secret key in memory on the target computing system, the attacker will need to know the positioning of the key in normally inaccessible memory relative to itself, so by simply migrating the process to another location, whether on a different core, virtual machine, physical machine, or process boundary, then the relative positioning of the key changes and breaks the attack.

A method is provided that includes monitoring a process being executed from a first computing location on a computing device for a trigger indicating a potential attack and detecting the trigger indicating the potential attack. Responsive to detecting the trigger indicating the potential attack, initiating an attack countermeasure by migrating the process to execute in a second computing location isolated from the first computing location, thereby breaking access to information at the first computing location.

A computing device is provided that includes a processor, a memory, and instructions stored on the memory that when executed by the processor direct the computing device to monitor a process being executed from a first computing location on the computing device for a trigger indicating a potential attack and detect the trigger indicating the potential attack. Responsive to detecting the trigger indicating the potential attack, initiate an attack countermeasure by migrating the process to execute in a second computing location isolated from the first computing location, thereby breaking access to information at the first computing location.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a schematic diagram of an operating environment for mitigating a malicious attack.

FIG. 2 illustrates a method to mitigate an attack initiated by a malicious actor in accordance with one embodiment.

FIG. 3 illustrates a schematic diagram of an operating environment for mitigating a malicious attack after migration to a second computing location.

FIG. 4 illustrates a schematic diagram of a scenario of an operating environment when the process is migrated from one CPU core to another CPU core.

FIG. 5 illustrates a schematic diagram of a scenario of an operating environment when the process is migrated from one host system to another host system.

FIG. 6A illustrates a schematic diagram illustrating components of a computing device.

FIG. 6B illustrates a schematic diagram illustrating components of a monitor system.

### DETAILED DESCRIPTION

A method to mitigate an attack initiated by a malicious actor by migration of the attacked process is provided. When evidence of an attack is detected on a computer program running on a computing system, there are a number of countermeasures that are possible depending on the type of attack. However, by migrating the attacked process away from a location where the attackers have access to the computing system (including the computer program and, perhaps, to other devices, components, and/or other software programs) to another location as described herein, it is possible to thwart common goals of the attacker. Moreover, by migrating the attacked process to a location where the attack cannot cause harm to the computer program or other computing devices associated with the computing device, it is possible for the process to continue to run without realizing that the attack mitigation has been performed.

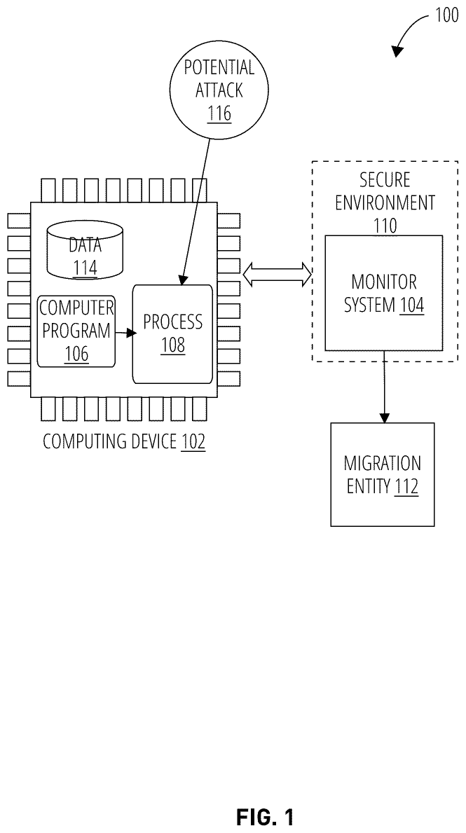

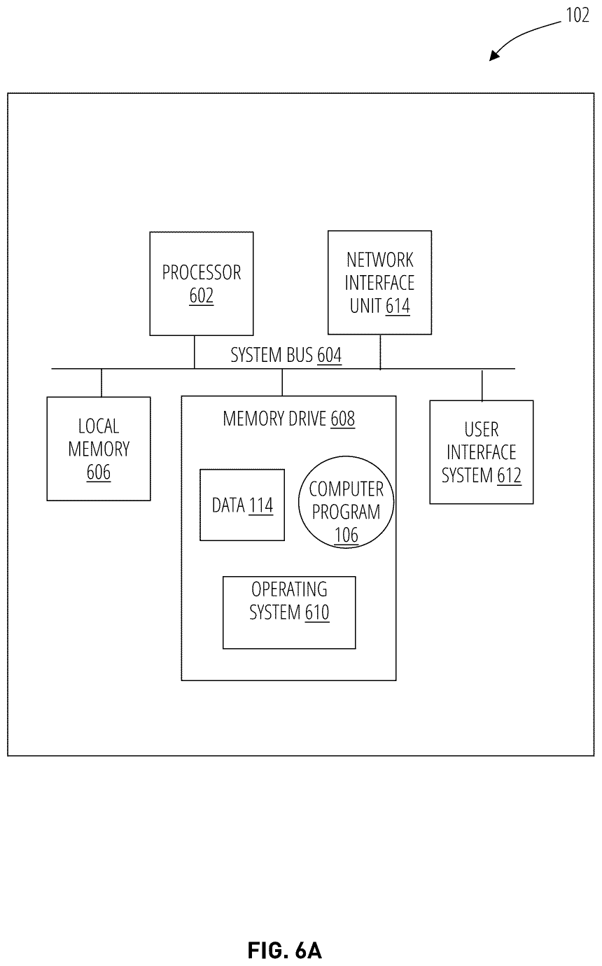

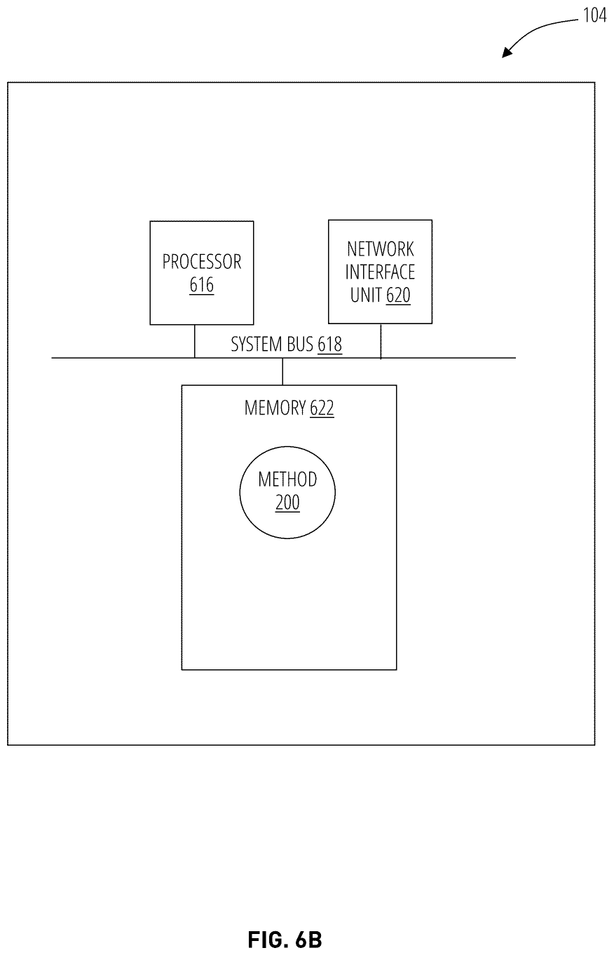

FIG. 1 illustrates a schematic diagram of an operating environment for mitigating a malicious attack. Referring to FIG. 1, operating environment 100 includes a computing device 102, which may be embodied as described with respect to FIG. 6A, and a monitor system 104, which may be part of computing device 102 or a separate computing device, embodied as described with respect to FIG. 6B, in communication with computing device 102.

Computing device 102 includes a processing element and memory. The processing element can be any processing element such as, but not limited to, a central processing unit (CPU), graphics processing unit (GPU), microcontroller, or computing unit (e.g., multiplier-accumulator (MAC) unit with memory). The processing element can also be virtualized, such as in emulated environments like QEMU (Quick Emulator). Memory can include volatile and non-volatile memory hardware and can include built-in (e.g., system on a chip and/or removable memory hardware. Examples of volatile memory include random-access memories (RAM, DRAM, SRAM). Examples of non-volatile memory include flash memory, various read-only memories (ROM, PROM, EPROM, EEPROM), phase change memory, magnetic and ferromagnetic/ferroelectric memories (MRAM, FRAM). It should be understood that there are different levels/hierarchy of memory and components that may be used (e.g., cache memories, processor registers, system RAM, disk drives, secondary storage, etc.). The memory can store data 114 and a computer program 106. The data 114 includes any information that may be accessed by computer program 110 during runtime and in some cases may be located on a separate device than computing device 102.

Although not shown, computing device 102 typically includes an operating system or other piece of software that performs one or more functions of an operating system (e.g., which may be found as part of firmware). Functions of an operating system include loading a program (e.g., computer program 106) into a memory space used by the processing element, directing the processing element to the memory address at which the program begins in order to begin execution of the program (i.e., as an instance of the program, which can also be referred to as a process 108), monitoring the process 108 while the process 108 is running, responding to requests by the process 108 for shared system resources, and removing the process 108 (and other related data) from the memory space. Process 108 can be defined as an instance of a computer program that is being sequentially executed by a computer system that has the ability to run several computer programs concurrently. While this definition of process is mostly referred to throughout the disclosure and figures, this is for exemplary purposes only. Alternately, process 108 can be a thread, a singular process, a process tree, a container, a virtual machine, or a (AWS-Amazon Web Service) lambda function or any other self-contained execution structure that lends itself to migration.

Monitor system 104 can monitor process 108 being executed from a first computing location on computing device 102 for a trigger indicating a potential attack 116 by the malicious actor. Process 108 can be executed locally, in a container running the code, or on a virtual machine, as examples. The potential attack 116 can be executing code as part of process 108, or can be a different process than process 108, however, still affecting process 108 in various ways. Thus, the potential attack 116 can be code running. e.g., attack code, on the computing device 102 or instigated by an external party, but still tainting the process 108. In addition, process 108 can include more than a single process; there can be multiple processes that are executing, and there can be other processes created by the process 108.

The monitor system 104 can include a software program. In order to keep the monitor system 104 inaccessible to process 108, the software program of the monitor system 104 runs in a secure environment 110. In some cases, the secure environment is a protected area of the chip (whether the same or different than that of the computing device 102). In some cases, the monitor system 104 may be part of a data center such as a cloud data center and may include specialized hardware such as a hardware security module (HSM). The computing device 102 is in communication with the monitor system 104 which may be internal to the computing device 102, external to the computing device 102, reachable via a network by the computing device 102, reachable locally by the computing device 102, etc.

A migration entity 112 in communication with the monitor system 104 performs the migration of the process 108 from the first computing location to a second computing location. The migration entity 112 that performs the migration can be any suitable computing device, or computing devices, depending on the class of attack that is occurring. For example, in some cases, the migration entity 112 can be a hypervisor having the ability to move virtual machines (VMs) around. In other cases, the migration entity 112 can be a container management daemon process that can relocate containers to a different location. In a further case, the migration entity 112 can be an operating system (OS) that can move a process from one CPU core to another CPU core.

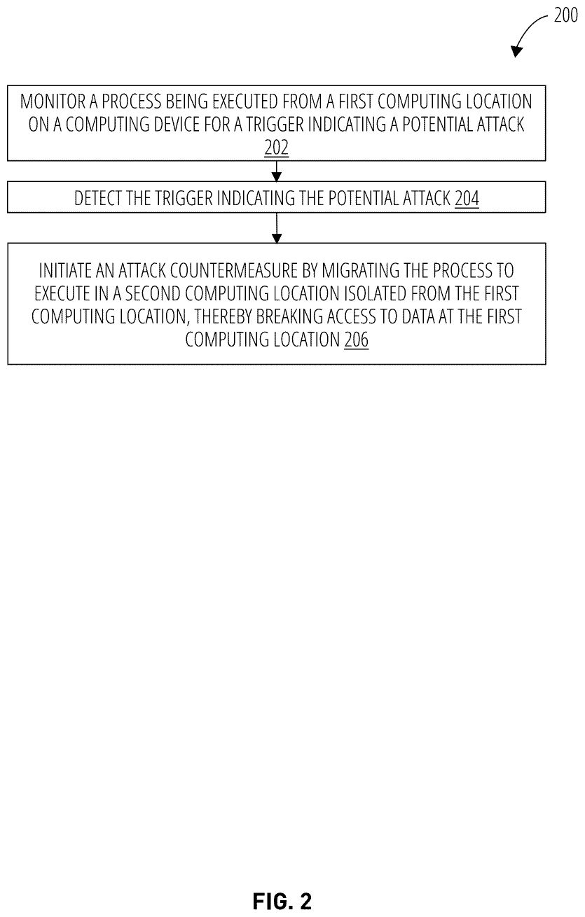

FIG. 2 illustrates a method to mitigate an attack initiated by a malicious actor in accordance with one embodiment. Method 200 can be performed by monitor system 104 as described with respect to FIG. 1 or associated computing system or component. Referring to FIG. 2, method 200 includes monitoring (202) a process 108 being executed from a first computing location on a computing device 102 for a trigger indicating a potential attack. Method 200 further includes detecting (204) the trigger indicating the potential attack. Responsive to detecting the trigger that indicates the potential attack, method 200 includes initiating (206) an attack countermeasure by migrating the process 108 to execute in a second computing location isolated from the first computing location. This mitigation breaks access to data at the first computing location.

In operation 202, the monitor system 104 monitors for the trigger indicating the potential attack 116. The monitoring, as described previously, can be performed by the monitor system 104 in a secure environment 110.

In operation 204, the monitor system 104 detects the trigger indicating the potential attack 116. The presence of a potential ongoing attack can be detected through any available means. In some cases, the monitor system 104 includes a behavioral system-level detector that monitors activity of a processing unit of the computing device 102. The system-level detector can detect behaviors that are known to exhibit characteristics of an attack or an undesirable behavior. When the system-level detector detects a potential attack or other undesirable behavior on or associated with the process 108, the system-level detector can issue an alert with information of the behavior triggering the alert. The issued alert can then be used as the trigger by the monitor system 104 to initiate the migration. In another case, the monitor system 104 is a behavioral system-level detector. In the case that the monitor system 104 is a behavioral system-level detector, the trigger indicating an attack has occurred, is the alert. The alert would then be sent by the behavioral system-level detector directly to the migration entity 112 or indirectly to the migration entity 112 through a controller that communicates with the migration entity 112. It should be understood, however, that an attack can be detected by other means as well, such as, for example, a network traffic monitor and/or a system call monitor. The trigger can be in any suitable format and include any appropriate information. For example, the trigger may be a simple one-bit notification that behavior associated with a potential attack has occurred.

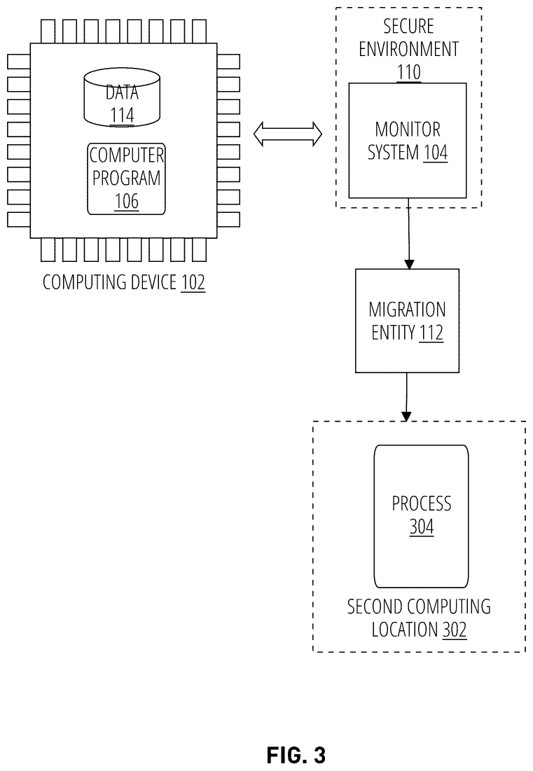

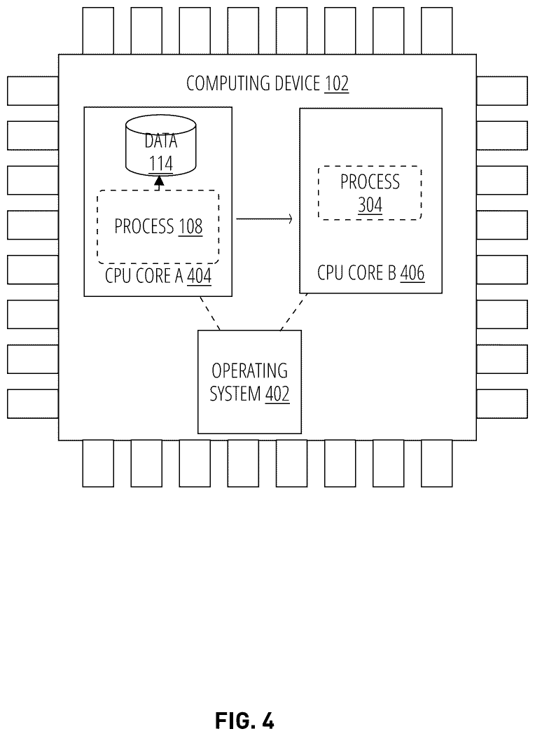

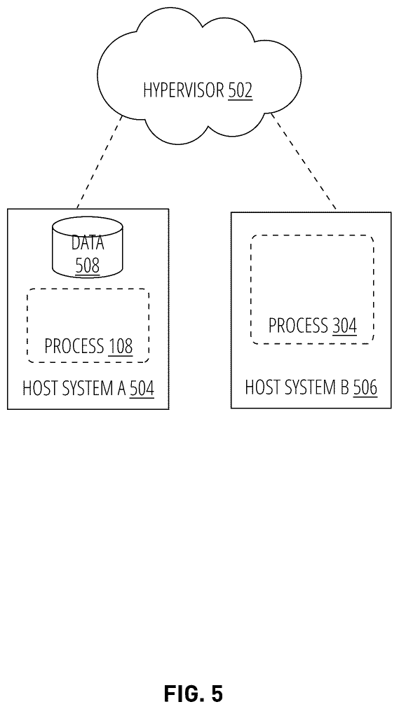

In operation 206, in some cases, initiating the attack countermeasure responsive to detecting the trigger includes notifying the migration entity 112 to migrate the process 108 to a second computing location while the potential attack is ongoing. The process 108 can then be migrated by the migration entity 112 to the second computing location, e.g., a computing environment, where the process 108 can execute without causing harm, or reduce the likelihood of causing harm, to the computer program 106 and the data 114 at the first computing location, for example as illustrated in FIG. 3, FIG. 4, and FIG. 5, described in detail below.

After being notified to migrate the process 108, the migration entity 112 intentionally migrates the process 108 to execute in the second computing location where the information the potential attack 116 targets is no longer accessible by the process 108, thereby potentially breaking the attack pattern. This information may for instance include the data 114 or other processes associated with the computing device 102.

In some cases, the initiation of the attack countermeasure can include additional pre/post conditional operations. For example, instrumentation can be performed at the second computing location. The instrumentation can include binary instrumentation. Binary instrumentation can include the process of introducing new code into a computer program without changing its overall behavior. In some cases, the instrumentation can include monitoring system calls and/or network traffic. Information can be captured during execution of the process 108 in the second computing location and analyzed to assist with future protective measures and countermeasures. The instrumenting can include performing an event trace capture on the process while the process executes in the second computing location to identify features of an event stream performed by the process. Behavior of a circuit, such as a processor or other device, including the success of commands or particular operations can be represented as a series of events in an event stream. These events describe software behaviors. The event trace capture may enable understanding of when and where the potential attack and its associated code can execute. In some cases, the entire environment of the second computing location can be cloned with access to assets removed or replaced with dummy assets in order to fully analyze the suspicious process. Additional pre/post operations may also include flushing a storage device, etc.

FIG. 3 illustrates a schematic diagram of an operating environment for mitigating a malicious attack after migration to a second computing location. Referring to FIG. 3, operating environment 100 of FIG. 1 is now shown after the migration entity 112 migrates the process 108 to the second computing location 302. The migrated process 304 can be an infected process, e.g., process 108 with attack code embedded within the process 108, only the potential attack 116, e.g., just attack code, or simply the process 108 without the potential attack 116. In the second computing location 302, process 304 cannot do any harm to the computer program 106 on the computing device 102 and no longer has access to the data 114 and other information associated with computing device 102. In some cases, if data 114 is remotely loadable, e.g., in the case of opaque keys, the location the remotely loadable data is stored after the migration is likely to be different from the computing device 102. In this case, then, the potential attack 116 is likely to fail.

In some cases, the second computing location 302 can be a sandbox environment. Migration entity 112 migrates the process to operate in a sandbox environment, e.g., an isolated virtual machine, in which the process 304 can execute without affecting network resources. Advantageously, instead of a user deciding to run code in a sandbox environment, the sandbox environment is managed by the monitor system 104 or other entity and code executing at computing device 102 may be migrated as soon as the monitor system 104 is triggered by a potential attack. The sandbox environment can be on the same computing device 102 or on another computing device altogether. In the sandbox environment, the potential attack 116 will not find the information it targets, therefore, cannot execute as intended and, likely, breaks down. For example, if the trigger indicates a suspicious behavior, migrating the process, by the migration entity 112, to a sandbox environment where access to the data 114 is broken, would be appropriate.

In some cases, the process is migrated to a virtual machine (VM) with the same runtime configuration as computing device 102. After the process is migrated, to the virtual machine, for example, the process 304 can be instrumented and executed in the virtual machine environment so that the information the potential attack 116 is targeting can be determined by the migration entity 112 before the process 304 fails.

There are various scenarios of what the migration entity 112 can represent, what types of undesirable behavior the potential attack 116 describes, and where, e.g., the second computing location, the process can be moved. Depending on the type of potential attack, e.g., type of undesirable behavior(s), as indicated by the trigger, a particular second computing location may be more appropriate than another computing environment. For example, a computing device specific attack such as a transient execution attack exploits the vulnerabilities of a processor on a computing device by accessing data currently being processed on the computing device. Typically, a countermeasure employed for a transient execution type of attack to process 108, is to flush the storage device, e.g., a cache, where the data is stored. This is an example of an expensive and irreversible process. When the trigger indicates that the potential attack 116 is a transient execution type of attack as detected by the monitor system 104, the migration entity 112 can migrate the process to a CPU core having non-intersecting access devices with computing device 102.

In some cases, the malicious actor may utilize a side channel attack, where an adversary targets information about the secure or sensitive information from the circuit's power signatures or electromagnetic signatures or other physical signatures, to access a storage device, such as a cache, to obtain the information stored there. In an embodiment, when the trigger indicates that the potential attack 116 is a side channel attack as detected by monitor system 104, the migration entity 112, such as an operating system, can migrate the process 108 to a CPU core that does not share the storage device with computing device 102.

In some cases, a defender can utilize a tripwire, e.g., hardware, on a portion of a storage device representing regions of memory that should never be reached or accessed. If this portion of the storage device is accessed, e.g., the tripwire is tripped, the tripwire sends a notification that an attack has occurred. The migration entity 112, in this case, can migrate the process 108 to another CPU core. Process 108 can then be analyzed by instrumenting the CPU core and executing the process 108 so that the information the potential attack 116 is targeting can be determined by the migration entity 112. The migration entity 112, in this case, can be an operating system.

In some cases, a defender can utilize memory tagging extensions to tag memory with a small value to annotate the memory. In addition, any pointers used to access the memory can also be tagged with the same tag as the memory. Thus, when memory is accessed with a pointer having a tag that doesn't match the tag on the memory itself, an error is generated. The generated error can trigger the migration entity 112 to move process 108 to the second computing location 302. A migration entity 112, such as the operating system 402 in this case, can migrate the process 108 to another CPU core.

All of the above-described scenarios may be described by FIG. 4. FIG. 4 illustrates a schematic diagram of a scenario of an operating environment when the process 108 is migrated from one CPU core to another CPU core. For example, FIG. 4 illustrates an operating system 402 as the migration entity, performing a migration of process 108 from CPU core A 404 to CPU Core B 406. CPU Core B 406 can be co-located on the same hardware, e.g., computing device 102, as CPU core A 404, as shown, as long as, the process 304 no longer has access to data 114 and other information associated with CPU core A 404.

FIG. 5 illustrates a schematic diagram of a scenario of an operating environment when the process is migrated from one host system to another host system. In the context of this example, the process is a self-contained execution structure such as a virtual machine or container. In some cases, the process 108 can be migrated to a new host system. For example, if the trigger indicates that the ongoing attack is manipulating or inspecting a co-tenant on a cloud host, the migration entity 112 can migrate the process 108 to another host system or virtual machine. Referring to FIG. 5, hypervisor 502 can migrate the process 108 from host system A 504 to host system B 506. Because the process 304 is now running in another computing environment with a different system context, the potential attack 116 will likely fail. While several specific scenarios of types of attacks and the migration attack countermeasure(s) that can be employed for the specific scenario are provided, other attack scenarios with an appropriate migration attack countermeasure(s) can also be mitigated by the proposed method.

FIG. 6A illustrates a schematic diagram illustrating components of a computing device. It should be understood that aspects of the system described herein are applicable to both mobile and traditional desktop computers, as well as server computers and other computer systems. Components of the computing device may represent a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen as some examples. Accordingly, more or fewer elements described with respect to computing device may be incorporated to implement a particular computing system.

Referring to FIG. 6A, a computing device 102 can include at least one processor 602 connected to components via a system bus 604, a local memory 606, and a memory drive 608. A processor 602 processes data 114 according to instructions of computer program 106, and/or operating system 610. The computer program 106 may be loaded into the memory drive 608 and run on or in association with the operating system 610. In some cases, such as when the monitor system 104 is part of computing device 102, computing device 102 includes instructions for performing the method 200 as described. The computing device 102 can further include a user interface system 612, which may include input/output (I/O) devices and components that enable communication between a user and the computing device 102. Computing device 102 may also include a network interface unit 614 that allows the system to communicate with other computing devices, including server computing devices and other client devices, over a network.

FIG. 6B illustrates a schematic diagram illustrating components of a monitor system. It should be understood that aspects of the system described herein are applicable to both mobile and traditional desktop computers, as well as server computers and other computer systems. Accordingly, more or fewer elements described with respect to monitor system may be incorporated to implement a particular computing system that is separate from computing device 102.

Referring to FIG. 6B, a monitor system 104 can include at least one processor 616 connected to components via a system bus 618, a memory 622 storing instructions for performing method 200, and a network interface unit 620 that enables the monitor system 104 to communicate with computing device 102 and other devices over a network. The processor 616 can be any processing unit such as, but not limited to, a CPU, GPU, microcontroller, or computing unit (e.g., MAC unit with memory). Memory can include volatile and non-volatile memory hardware and can include built-in (e.g., system on a chip and/or removable memory hardware. Examples of volatile memory include random-access memories (RAM, DRAM, SRAM). Examples of non-volatile memory include flash memory, various read-only memories (ROM, PROM, EPROM, EEPROM), phase change memory, magnetic and ferromagnetic/ferroelectric memories (MRAM, FeRAM). Although a single memory block is shown in the drawing, it should be understood that there are different levels/hierarchy of memory and components that may be used (e.g., cache memories, processor registers, system RAM, disk drives, secondary storage, etc.).

As illustrated by the various examples and scenarios herein, it can be seen that in operation, a monitor system monitoring a computer program for a wide set of ongoing software or microarchitectural attack utilizes, as a mitigation to the ongoing attack, migration of the process to another location. The location, e.g., an alternate computing environment, can be a sandbox environment or other appropriate alternate computing location, where the malicious actor can no longer attack the computer program. Furthermore, the process can be analyzed by instrumenting the sandbox environment, for example, and executing the process in the sandbox environment.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method, comprising:
monitoring a process being executed from a first computing location on a computing device for a trigger indicating a potential attack;
detecting the trigger indicating the potential attack; and
responsive to detecting the trigger indicating the potential attack:
initiating an attack countermeasure by migrating the process to execute in a second computing location isolated from the first computing location, thereby breaking access to information at the first computing location.

2. The method of claim 1, wherein the monitoring is performed, by a monitor system, within a secure environment.

3. The method of claim 2, wherein migrating the process to execute in the second computing location isolated from the first computing location is performed by a migration entity separate from the monitor system.

4. The method of claim 1, wherein initiating the attack countermeasure includes notifying a migration entity to perform the migration of the process from the first computing location to execute in the second computing location.

5. The method of claim 4, wherein the migration entity migrates the process to a CPU core that does not share data with the computing device in response to the trigger indicating that the potential attack is a transient execution attack.

6. The method of claim 4, wherein the migration entity is an operating system.

7. The method of claim 4, wherein migration entity migrates the process to a CPU core that does not share data with the computing device in response to the trigger indicating that the potential attack is a side channel attack on a storage device including the data.

8. The method of claim 4, wherein the migration entity migrates the process to a new host system in response to the trigger indicating that the potential attack is a manipulation or inspection of a co-tenant in a cloud host.

9. The method of claim 8, wherein the migration entity is a hypervisor.

10. The method of claim 4, wherein the migration entity migrates the process to an instrumented CPU core in response to the trigger indicating that the process has tripped a tripwire.

11. The method of claim 10, further comprising executing the process on the instrumented CPU core to determine the information the process is targeting.

12. The method of claim 4, wherein the migration entity migrates the process to a CPU core in response to the trigger indicating that the process has accessed memory with a pointer having a tag that does not match the tag on the memory.

13. The method of claim 1, wherein the second computing location is a sandbox environment.

14. The method of claim 1, further comprising after migrating the process to the second computing location, instrumenting the process and executing the process in the second computing location to determine information the potential attack is targeting.

15. The method of claim 14, further comprising performing an event trace capture on the process while the process executes in the second computing location to identify features of an event stream performed by the process.

16. The method of claim 15, wherein the second computing location is a sandbox environment.

17. The method of claim 1, wherein the second computing location is a virtual machine environment with a same runtime configuration as the computing device.

18. A computing device, comprising:
a processor;
a memory;
instructions stored on the memory that when executed by the processor direct the computing device to:
monitor a process being executed from a first computing location on the computing device for a trigger indicating a potential attack;
detect the trigger indicating the potential attack; and
responsive to detecting the trigger indicating the potential attack:
initiate an attack countermeasure by migrating the process to execute in a second computing location isolated from the first computing location, thereby breaking access to information at the first computing location.

19. The computing device of claim 18, wherein the computing device monitors the process within a secure environment.

20. The computing device of claim 18, wherein migrating the process to execute in a second computing location isolated from the first computing location is performed by a migration entity separate from the computing device.
